(19) United States
(12) Patent Application Publication
(10) Pub. No.: US 2023/0025040 A1
(43) Pub. Date: Jan. 26, 2023

(54) ELECTROSTATIC LATENT IMAGE DEVELOPING TONER AND PRODUCTION METHOD OF ELECTROSTATIC LATENT IMAGE DEVELOPING TONER

(71) Applicant: Konica Minolta, Inc., Tokyo (JP)

(72) Inventor: Kazuya ISOBE, Tokyo (JP)

(21) Appl. No.: 17/804,113

(22) Filed: May 26, 2022

(30) Foreign Application Priority Data
Jun. 4, 2021 (JP) 2021-094005

(51) Int. Cl. G03G 9/087; C08L 25/16; C08L 33/10; C08L 67/07

(52) U.S. Cl. CPC G03G 9/08711; C08L 25/16; C08L 33/10; C08L 67/07; C08L 2205/03

(57) ABSTRACT

An electrostatic latent image developing toner includes toner base particles including a binding resin and a colorant. The binding resin is at least one of: a first polymer having a first structural unit represented by a general formula (1) below and a second polymer having a second structural unit represented by a general formula (2) below; and a copolymer having at least one of the first structural unit and the second structural unit.

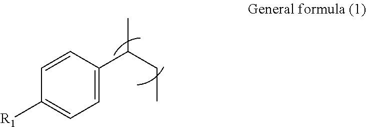

In the general formula (1), R₁ represents a hydrogen atom or an alkoxy group having one to three carbon atoms.

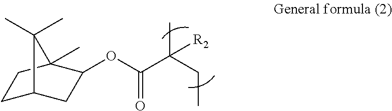

In the general formula (2), R₂ represents a hydrogen atom or an alkyl group having one to three carbon atoms.

### CROSS-REFERENCE TO RELATED APPLICATIONS

The entire disclosure of Japanese Patent Application No. 2021-094005 filed on Jun. 4, 2021 is incorporated herein by reference in its entirety.

### BACKGROUND

### Technological Field

The present invention relates to an electrostatic latent image developing toner and a method of producing the electrostatic latent image developing toner.

More specifically, the present invention relates to an electrostatic latent image developing toner that suppress electrostatic adhesion of printed materials while satisfying a heat-resistant storage property and a low-temperature fixing property.

### Description of the Related Art

In recent years, in the field of printing for electrophotographic image formation, electrostatic latent image developing toner (hereinafter, also simply referred to as a “toner”) is desired to enable lower power consumption, faster printing, diversity of imaging media, higher image quality, reduced environmental burden, and the like.

The properties required for such toners include so-called low-temperature fixing property, which means that toner images can be fixed at lower temperatures than when conventional toners are used, and improved fixing strength. Furthermore, as toners are used not only in the conventional office market but also in the light printing market, they are often post-processed to add value to products, such as varnishing and laminating on the surface of printed materials. Therefore, toners are required to be compatible with the post-treatment processes of printed materials.

Toners usually include a binding resin (hereinafter also referred to as “toner binder”) that has a function as a binder. Hybrid resins such as a styrene acrylic resin, a polyester resin, and a polyester resin with grafted acrylic polymerization segments are known to be used as this binding resin. In response to the above demands, there are known technologies to improve the low-temperature fixing property and the like by improving these binding resins and the like (for example, see JP 2007-279714 A, JP 2008-287229 A, and JP 2010-15159 A).

In addition, not only in the light printing market, the toner particle size is required to be smaller in order that the image quality of printed materials improved, resulting in a shift in toner manufacturing methods from the conventional pulverization method to chemical methods. The smaller toner particle size allows the toner to adhere more uniformly to the electrostatic latent image, thereby realizing higher image quality.

In this way, by using a binding resin that can be fixed at a lower temperature and by decreasing the toner particle size, it has been possible to realize lower power consumption, faster printing, higher image quality, and reduced environmental burden.

Printed materials are output while coming into contact with many conveyance rollers in the conveyance path during printing. The printed materials are charged due to the contact with the conveyance rollers, etc., and as a result, there was a problem that the output printed materials were electrostatically adhere to each other. In particular, the faster printing makes the time available for leakage of the charge shorter and the electrostatic adhesion stronger. Therefore, paper handling was sometimes difficult in post-processing such as varnishing and laminating due to appearance of problems that the printed materials were sent overlapping each other. When using more insulating media such as polypropylene film or stone paper, the electrostatic adhesion could become even more apparent.

To solve this problem, electrostatic adhesion has been suppressed by leakage of electric charge by humidifying the entire printing environment or by installing a humidification unit in the printing machine itself. However, keeping the printing environment at an appropriate humidity level increases costs. Also, only installing a humidification unit in the printing machine itself was not sufficient to suppress electrostatic adhesion.

Alternatively, a method using a resin that easily leaks charge may be used as a binding resin to suppress electrostatic adhesion. However, the conventional resin that easily leak charge has a problem of deteriorating the heat-resistant storage property due to large interaction of the binding resin.

### SUMMARY

The present invention has been made in view of the above circumstances, and the problem to be solved is to provide an electrostatic latent image developing toner and a manufacturing method thereof that can suppress electrostatic adhesion of printed materials while satisfying the heat-resistant storage property and the low-temperature fixing property.

In order to solve the above problems, the present inventor has examined the causes of the above problems and the like, and found that by including a polymeric compound having a specific structural unit as a binding resin, it is possible to provide an electrostatic latent image developing toner etc. that suppress electrostatic adhesion of printed materials while satisfying the heat-resistant storage property and the low-temperature fixing property, and thus arrived at the present invention.

In other words, the above problems related to the present invention are solved by the following means.

To achieve at least one of the above-mentioned objects, according to an aspect of the present invention, an electrostatic latent image developing toner reflecting one aspect of the present invention includes:

toner base particles including a binding resin and a colorant, the binding resin being at least one of:
a first polymer having a first structural unit represented by a general formula (1) below and a second polymer having a second structural unit represented by a general formula (2) below; and
a copolymer having at least one of the first structural unit and the second structural unit,

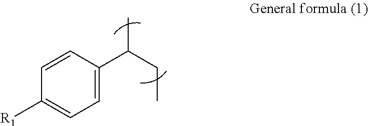

wherein, in the general formula (1), R₁ represents a hydrogen atom or an alkoxy group having one to three carbon atoms, and

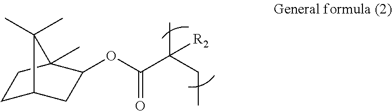

wherein, in the general formula (2), R₂ represents a hydrogen atom or an alkyl group having one to three carbon atoms.

According to another aspect of the present invention, a method of producing an electrostatic latent image developing toner comprising toner base particles including a binding resin and a colorant reflecting one aspect of the present invention includes:

preparing a particle dispersion liquid of the binding resin by copolymerizing a first monomer having a structure represented by a general formula (3) below and a second monomer having a structure represented by a general formula (4) below,

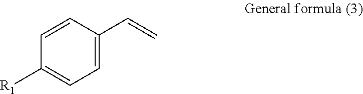

wherein, in the general formula (3), R₁ represents a hydrogen atom or an alkoxy group having one to three carbon atoms, and

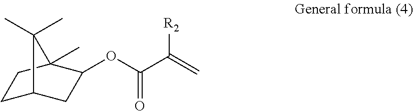

wherein, in the general formula (4), R₂ represents a hydrogen atom or an alkyl group having one to three carbon atoms.

### DETAILED DESCRIPTION OF EMBODIMENTS

Hereinafter, one or more embodiments of the present invention will be described with reference to the drawings. However, the scope of the invention is not limited to the illustrated examples.

The mechanism by which the effect of the invention is exhibited or the mechanism by which it works is not clear, but is presumed to be as follows.

The properties required for toner are diverse, and include optical properties, thermal properties (viscoelasticity), electrical properties (chargeability), and heat-resistant storage property. The toner is made up of various constituent materials to satisfy the aforementioned properties. The binding resin, one of the constituent materials of the toner, is required to control viscoelasticity, the heat-resistant storage property, and chargeability. Specifically, the average molecular weight, softening temperature, glass transition temperature (Tg), and the like are optimized according to the required properties by controlling the resin type, monomer composition, and manufacturing conditions.

One typical resin composition used as a binding resin is styrene acrylic resin. Viscoelasticity and heat-resistant storage property are controlled by using styrene as a hard segment having a high Tg and n-butyl acrylate as a soft segment having a low Tg as main ingredients. The molecular weight and hard segment/soft segment ratio have been studied and adjusted.

Although it is effective to lower the Tg of the binding resin by reducing the ratio of styrene having a high Tg in order to achieve the low-temperature fixing property, the heat-resistant storage property is deteriorated at the same time. Because of this trade-off relationship between the low-temperature fixing property and the heat-resistant storage property, there are design limitations, for example, the Tg needs to be 45° C. or higher.

As for the control of chargeability, the saturated charge amount is proportional to the inverse of the dielectric tangent tans (dielectric loss (ϵ″)/dielectric constant (ϵ′)). The dielectric tangent tans depends on the resin composition, and the chargeability can be controlled by adjusting the composition ratio. It is known that the dielectric tangent tans of styrene-based resins is low and that of (meth)acrylate-based resins is high. The dielectric tangent tans is preferably large to accelerate the leakage of charge. In order to suppress electrostatic adhesion, it is effective to reduce the styrene ratio, which has a small dielectric loss tangent tans.

However, control by reduction of the styrene ratio is practically difficult since it results in deterioration of the heat resistant storage property as mentioned above. Considering the above problems, tanδ can be increased while the glass transition temperature is maintained as a result of introduction of a structure represented by general formula (1) having a high Tg, and a structure represented by general formula (2) having a high Tg and a high tanδ. As a result, it is possible to provide an electrostatic latent image developing toner that causes no deterioration of the heat-resistant storage property, satisfaction of the low-temperature fixing property, suppression of electrostatic adhesion of printed materials, and excellent productivity including the post-treatment processes.

The reason why the toner of the present invention can suppress electrostatic adhesion of printed materials while satisfying the low-temperature fixing property can be presumed as follows. By introducing the structure represented by general formula (2) having a bulky substituent, it is possible to keep the intermolecular force between polymer chains low, thus suppressing electrostatic adhesion due to large tans and maintaining the heat-resistance storage property and the low-temperature fixing property.

By such an expression or action mechanism, it is possible to provide an electrostatic latent image developing toner that suppress electrostatic adhesion of printed materials while satisfying the heat-resistant storage property and the low-temperature fixing property.

An electrostatic latent image developing toner of the present invention includes toner base particles including a binding resin and a colorant, and the binding resin is at least one of: a first polymer having a first structural unit represented by the above general formula (1) above and a second polymer having a second structural unit represented by the above general formula (2) above; and a copolymer having at least one of the first structural unit and the second structural unit.

This feature is a technical feature common to or corresponding to each of the following embodiments.

In an embodiment of the electrostatic latent image developing toner according to the present invention, from the viewpoint of uniform charge leakage to suppress electrostatic adhesion, preferably, the binding resin is a copolymer having the first structural unit and the second structural unit.

In an embodiment of the electrostatic latent image developing toner according to the present invention, from the viewpoint of the low-temperature fixing property, in the above general formula (1), R₁ preferably represents a hydrogen atom or a methoxy group, and more preferably a methoxy group.

In an embodiment of the electrostatic latent image developing toner according to the present invention, from the viewpoint of suppressing electrostatic adhesion, in the above general formula (2), R₂ preferably represents a hydrogen atom or a methyl group, and more preferably a hydrogen atom.

In an embodiment of the electrostatic latent image developing toner according to the present invention, from the viewpoint of adjusting the thermophysical property, preferably, the copolymer further has a third structural unit that is different from the first structural unit and the second structural unit.

In an embodiment of the electrostatic latent image developing toner according to the present invention, from the viewpoint of balance of the low-temperature fixing property and suppressing electrostatic adhesion, preferably, the composition ratio X represented by the following formula (I) below is in a range of 25 to 75% by mass.

X [mass %]=W₁/(W₁W₂)×100 formula (I):

In the formula (I), W₁ represents a mass of the first structural unit in a total binding resin, and W₂ represents a mass of the second structural unit in the total binding resin.

In an embodiment of the electrostatic latent image developing toner according to the present invention, from the viewpoint of the heat-resistant storage property, the third structural unit is preferably derived from at least one of an acrylic ester and a methacrylic ester.

In an embodiment of the electrostatic latent image developing toner according to the present invention, from the viewpoint of the heat-resistant storage property, the third structural unit is preferably derived from at least one of acrylic acid, n-butyl acrylate, 2-ethylhexyl acrylate, and methacrylic acid.

In a method of producing an electrostatic latent image developing toner according to the present invention, the electrostatic latent image developing toner includes toner base particles including a binding resin and a colorant, and the method includes preparing a particle dispersion liquid of the binding resin by copolymerizing a first monomer having a structure represented by general formula (3) and a second monomer having a structure represented by the above general formula (4).

Hereinafter, the present invention, its constituent elements, and modes and embodiments for carrying out the present invention will be described. In this application, “to” is used in the sense that it includes the numerical values described before and after “to” as the lower and upper limits.

### [Electrostatic Latent Image Developing Toner of Present Invention]

The electrostatic latent image developing toner according to the present invention is characterized by including toner base particles including a binding resin and a colorant, the binding resin being at least one of: a first polymer having a first structural unit represented by the above general formula (1) and a second polymer having a second structural unit represented by the above general formula (2); and a copolymer having the first structural unit and the second structural unit.

In the present specification, the “toner base particles” constitute the base of the “toner particles”. The “toner base particles” contains at least a binding resin and a colorant, and also contains other constituent components such as a mold release agent and a charge control agent, if necessary. The “toner base particles” is referred to as a “toner particle” after addition of an external additive. The “toner” refers to an aggregate of the “toner particles”.

### <Binding Resin>

The electrostatic latent image developing toner of the present invention is characterized in that it satisfies at least one of the following requirements A and B. From the viewpoint of enabling uniform charge leakage to suppress electrostatic adhesion, it particularly preferably satisfies requirement B.

Requirement A: The toner base particles include, as the binding resin, “a polymer having the first structural unit represented by the following general formula (1)” and “a polymer having the second structural unit represented by the following general formula (2)”.

Requirement B: The toner base particles include, as the binding resin, “a copolymer having the first structural unit represented by the following general formula (1) and the second structural unit represented by the following general formula (2)”.

Hereinafter, the “polymer having the first structural unit represented by the following general formula (1)” is also simply referred to as the “polymer having the first structural unit”, the “polymer having the second structural unit represented by the following general formula (2)” is also simply referred to as the “polymer having the second structural unit”, and the “copolymer having the first structural unit represented by the following general formula (1) and the second structural unit represented by the following general formula (2)” is also simply referred to as the “copolymer having the first structural unit and the second structural unit”.

The “copolymer having the first structural unit and the second structural unit” corresponds to both the “polymer having the first structural unit” and the “polymer having the second structural unit”. Therefore, the requirement B is a requirement that further limits the requirement A.

In the following description, the “polymer having the first structural unit” and the “polymer having the second structural unit” are collectively referred to as the “polymer according to the present invention”. The “polymer according to the present invention” also includes the “copolymer having the first structural unit and the second structural unit”.

### (First Structural Unit)

The first structural unit is a structural unit represented by the following general formula (1).

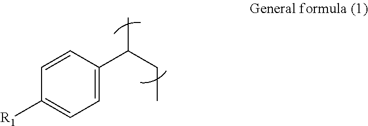

In the general formula (1), R₁ represents a hydrogen atom or an alkoxy group having 1 to 3 carbon atoms. Specific examples of the alkoxy group having 1 to 3 carbon atoms include a methoxy group, an ethoxy group, an n-propoxy group, an iso-propoxy group, an n-butoxy group, and a t-butoxy group. R₁ is preferably a hydrogen atom or a methoxy group from the viewpoint of the low-temperature fixing property, and is particularly preferably a methoxy group.

### (Second Structural Unit)

The second structural unit is a structural unit represented by the following general formula (2).

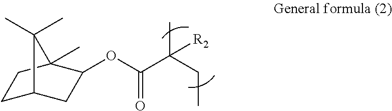

In the general formula (2), R₂ represents a hydrogen atom or an alkyl group having 1 to 3 carbon atoms. Specific examples of the alkyl group having 1 to 3 carbon atoms include a methyl group, an ethyl group, an n-propyl group, an iso-propyl group, an n-butyl group, and a t-butyl group. R₁ is preferably a hydrogen atom or a methyl group from the viewpoint of suppressing electrostatic adhesion, and is particularly preferably a hydrogen atom.

The “polymer having the first structural unit” can be synthesized by polymerizing a first monomer having the structure represented by the following general formula (3) as a polymerization material. R₁ in the general formula (3) is defined in the same way as R₁ in the above general formula (1).

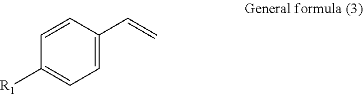

Specific examples of the first monomer include, but are not limited to, the following exemplary compounds M1 to M5.

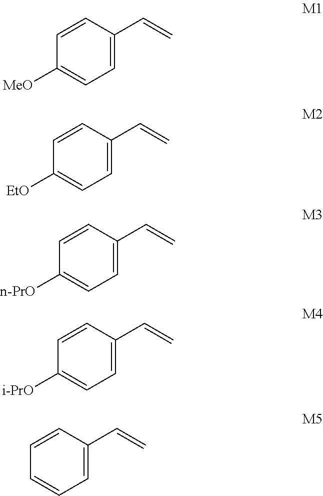

The polymerization material of the “polymer having the first structural unit” may be a combination of two or more of the first monomer, or a combination of the first monomer with other monomer(s).

The “polymer having the second structural unit” can be synthesized by polymerizing a second monomer having the structure represented by the following general formula (4) as a polymerization material. R₂ in the general formula (4) is defined in the same way as R₂ in the above general formula (2).

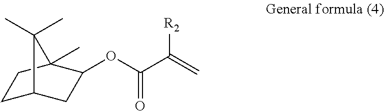

Specific examples of the second monomer include, but are not limited to, the following exemplary compounds M6 to M10.

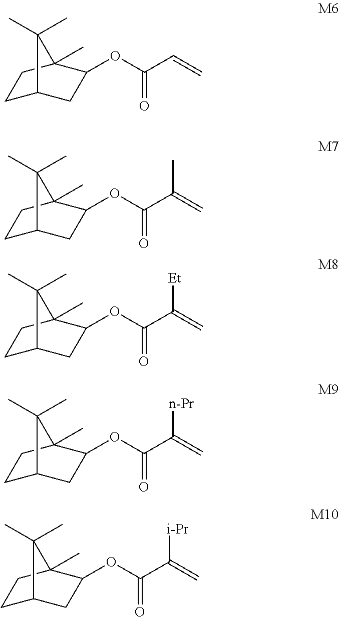

The polymerization material of the “polymer having the second structural unit” may be a combination of two or more of the second monomer, or a combination of the second monomer with other monomer(s).

The “copolymer having the first structural unit and the second structural unit” can be synthesized by combining at least one of the above first monomer and at least one of the above second monomer as a polymerization material.

### (Third Structural Unit)

The “third structural unit” according to the present invention refers to a structural unit that is different from the first structural unit and the second structural unit among the structural units in the “polymer according to the present invention.

From the viewpoint of adjusting the thermophysical property, the “polymer according to the present invention” is preferably a copolymer further having a third structural unit using a polymerization material combining a monomer (hereinafter also referred to as a “third monomer”) different from the first monomer and second monomer.

Examples of third monomer include styrene monomers such as α-methylstyrene, o-methylstyrene, m-methylstyrene, p-methylstyrene, o-ethylstyrene, m-ethylstyrene, p-ethylstyrene, o-acetoxystyrene, m-acetoxystyrene, and p-acetoxystyrene; acrylic acid esters such as methyl acrylate, ethyl acrylate, isopropyl acrylate, n-butyl acrylate, tert-butyl acrylate, isobutyl acrylate, n-octyl acrylate, 2-ethylhexyl acrylate, stearyl acrylate, lauryl acrylate, and phenyl acrylate; and methacrylic esters such as methyl methacrylate, ethyl methacrylate, n-butyl methacrylate, isopropyl methacrylate, isobutyl methacrylate, tert-butyl methacrylate, n-octyl methacrylate, 2-ethylhexyl methacrylate, stearyl methacrylate, lauryl methacrylate, phenyl methacrylate, dimethylaminoethyl methacrylate, and diethylaminoethyl methacrylate.

Monomers with ionic dissociative groups may also be used as the third monomer. Examples of the monomers with ionic dissociative groups include those having groups such as a carboxy group, a sulfonic acid group, or a phosphoric acid group. Specifically, they include acrylic acid, methacrylic acid, maleic acid, itaconic acid, fumaric acid, and the like.

The third monomer is preferably an acrylic acid ester, a methacrylic acid ester, acrylic acid, or methacrylic acid among the above from the viewpoint of easy adjustment of the glass transition temperature of the polymer. As for acrylic acid esters, n-butyl acrylate or 2-ethylhexyl acrylate are particularly preferred. In other words, the copolymer further including the third structural unit is preferably a copolymer further having a structural unit derived from these preferred third monomers.

The third monomer can be used alone or in combination of two or more monomers.

### (Peak Molecular Weight)

“The polymer according to the present invention” preferably has a peak molecular weight obtained from the molecular weight distribution in terms of polystyrene measured by gel permeation chromatography (GPC) within a range of 3500 to 35000, and more preferably within a range of 10000 to 30000. The peak molecular weight in such a range is preferable, since the polymer has an appropriate melt viscosity at the time of fixing, and a good fixing property and offset resistance can be achieved at the same time.

Here, “the peak molecular weight” is a molecular weight corresponding to an elution time of a peak top in the molecular weight distribution. When multiple peaks are present in the molecular weight distribution, the peak molecular weight is the molecular weight corresponding to the elution time of the peak top of the largest peak area ratio.

The peak molecular weight of the polymer is measured as follows. Specifically, using a device “HLC-8220” (manufactured by TOSOH Corporation) and a column set “TSK guard column +3×TSK gel Super HZM-M” (manufactured by TOSOH Corporation), tetrahydrofuran (THF) is flowed as a carrier solvent at a flow rate of 0.2 mL/min while maintaining the column temperature at 40° C., and the measurement sample is dissolved in the tetrahydrofuran at a concentration of 1 mg/mL under a dissolution condition in which the measurement sample is treated for 5 minutes using an ultrasonic disperser at room temperature (25° C.). Then, it is treated with a membrane filter having a pore size of 0.2 μm to obtain a sample solution, 10 μL of this sample solution is injected into the device together with the above carrier solvent, the molecular weight distribution of the measurement sample is detected using a refractive index detector (RI detector), and the peak molecular weight is determined.

### (Composition Ratio of Binding Resin)

From the viewpoint of balance of the fixing property and the offset resistance, the total mass of “the polymer according to the present invention” is preferably in the range of 65 to 99% by mass when the total mass of the binding resin is 100% by mass, more preferably in the range of 70 to 97% by mass, and still more preferably in the range of 75 to 95% by mass.

The toner of the present invention preferably has a composition ratio X represented by the following formula (I) in the range of 25 to 75% by mass, more preferably in the range of 30 to 70% by mass.

X [mass %]=W₁/(W₁+W₂)×100 Formula (I):

W₁: Mass of the first structural unit in the total binding resin

W₂: Mass of the second structural unit in the total binding resin

In “the polymer of the present invention,” the composition ratio of the third structural unit is not particularly limited and can be adjusted depending on the type of structural unit.

For example, when the third structural unit is a structural unit derived from an acrylic ester or a methacrylic ester, the composition ratio of the third structural unit is preferably in the range of 5 to 50% by mass when the total mass of the “polymer of the present invention” is 100% by mass, and more preferably in the range of 10 to 40% by mass.

When the third structural unit is a structural unit derived from a monomer having an ionic dissociative group, the composition ratio of the third structural unit is preferably in the range of 3 to 8% by mass when the total mass of the “polymer of the present invention” is 100% by mass.

### (Other Resin)

The toner base particles of the present invention may contain a resin other than the “polymer of the present invention” (hereinafter also referred to as “other resin”) as the binding resin.

Examples of the other resin include, for example, a polyester resin, a silicone resin, a polyolefin resin, a polyamide resin, or an epoxy resin. These can be used alone or in combination of two or more.

In the following, a polyester resin that can be used in the binding resin are described as the “other resin”.

The polyester resin that can be used as the binding resin is a known polyester resin obtained by polycondensation reaction of a divalent or more carboxylic acid (polycarboxylic acid component) and a divalent or more alcohol (polyalcohol component). The polyester resin may be an amorphous one or a crystalline one.

The valence of each of the polyvalent carboxylic acid component and the polyalcohol component is preferably two or three, and is particularly preferably two. Therefore, in the particularly preferred embodiments described below, each valence is two (that is, a dicarboxylic acid component and a diol component are used).

Examples of the dicarboxylic acid component include: saturated dicarboxylic acids such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid (dodecanedioic acid), 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, 1,18-octadecanedicarboxylic acid; unsaturated aliphatic dicarboxylic acids such as methylene succinic acid, fumaric acid, maleic acid, 3-hexendioic acid, 3-octendioic acid, and dodecenyl succinic acid; and unsaturated aromatic dicarboxylic acids such as phthalic acid, terephthalic acid, isophthalic acid, t-butyl isophthalic acid, tetrachlorophthalic acid, chlorophthalic acid, nitrophthalic acid, p-phenylene diacetic acid, 2,6-naphthalenedicarboxylic acid, 4,4′-biphenyldicarboxylic acid, and anthracenedicarboxylic acid. Further, lower alkyl esters and acid anhydrides thereof may also be used. The dicarboxylic acid component may be used alone or in combination of two or more.

In addition, a polyvalent carboxylic acid having three or more valences such as trimellitic acid and pyromellitic acid, an anhydride of the above carboxylic acid compound, or an alkyl ester having one to three carbon atoms can be used.

Examples of the diol component include: saturated aliphatic diols such as ethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18 -octadecanediol, 1,20-eicosanediol, and neopentyl glycol; unsaturated aliphatic diols such as 2-butene-1,4-diol, 3-butene-1,4-diol, 2-butyn-1,4-diol, 3-butin-1,4-diol, 9-octadecene-7,12-diol; aromatic diols such as bisphenols such as bisphenol A and bisphenol F; alkylene oxide adducts of bisphenols such as ethylene oxide adduct and propylene oxide adduct; and derivatives thereof. The diol component may be used alone or as a mixture of two or more of them.

The method for producing the polyester resin is not particularly limited and may include polycondensing (esterifying) the above polyvalent carboxylic acid component and the polyhydric alcohol component using a known esterification catalyst.

Catalysts usable in the production of polyester resins include compounds of alkali metals such as sodium and lithium; compounds comprising Group 2 elements such as magnesium and calcium; compounds of metals such as aluminum, zinc, manganese, antimony, titanium, tin, zirconium, and germanium; phosphorous acid compounds; phosphoric acid compounds; and amine compounds. Specifically, tin compounds include dibutyltin oxide, tin octylate, tin dioctylate, and salts thereof.

Examples of the titanium compound include titanium alkoxides such as tetranormalbutyl titanate (Ti(O-n-Bu)₄), tetraisopropyl titanate, tetramethyl titanate, and tetrastearyl titanate; titanium acylates such as polyhydroxytitanium stearate; titanium chelates such as titanium tetraacetylacetonate, titanium lactate, and titanium triethanolaminate.

Examples of the germanium compound include germanium dioxide.

Further, examples of the aluminum compound include polyaluminium hydroxide, aluminum alkoxide, and tributyl aluminate. These may be used alone or in combination of two or more of them.

The temperature for polymerization is not particularly limited, but is preferably within a range of 70 to 250° C. Also, the polymerization time is not particularly limited, but is preferably 0.5 to 10 hours. During polymerization, the inside of the reaction system may be reduced in pressure as needed.

The above polyester resin may be a hybrid polyester resin having a graft copolymer structure of a polyester polymerization segment and a styrene-acrylic polymerization segment graft.

### <Colorant>

The toner base particles according to the present invention include a colorant. As the colorant, a commonly known dye and pigment may be used.

Examples of a colorant to obtain a black toner include carbon black, a magnetic material, and iron-titanium complex oxide black. Examples of the carbon black that may be used include channel black, furnace black, acetylene black, thermal black, and lamp black.

Examples of a colorant to obtain a yellow toner include dyes such as C. I. Solvent Yellow 19, 44, 77, 79, 81, 82, 93, 98, 103, 104, 112, and 162; and pigments such as C. I. Pigment Yellow 14, 17, 74, 93, 94, 138, 155, 180, and 185.

Examples of a colorant to obtain a magenta toner include dyes such as C. I. Solvent Red 1, 49, 52, 58, 63, 111, and 122; and pigments such as C. I. Pigment Red 5, 48: 1, 53: 1, 57: 1, 122, 139, 144, 149, 166, 177, 178, and 222.

Examples of a colorant to obtain a cyan toner include dyes such as C. I. Solvent Blue 25, 36, 60, 70, 93, and 95; and pigments such as C. I. Pigment Blue 1, 7, 15, 60, 62, 66, and 76.

The colorant for obtaining the toner of each color may be used alone or in combination of two or more kinds for each color.

The content ratio of the colorant is preferably within a range of 0.5 to 20% by mass, and more preferably within a range of 2 to 10% by mass, when the total mass of the toner base particles is 100% by mass.

### <Mold Releasing Agent>

The toner base particles according to the present invention may contain a mold releasing agent. The mold releasing agent is preferably a fatty acid ester wax.

Examples of fatty acid ester wax include behenyl behenate, stearyl stearate, behenyl stearate, stearyl behenate, butyl stearate, propyl oleate, hexadecyl palmitate, methyl lignocerate, glycerin monostearate, diglyceryl distearate, pentaerythritol tetrabehenate, diethylene glycol monostearate, dipropylene glycol distearate, sorbitan monostearate, cholesteryl stearate, trimethylol propantribehenate, pentaerythritol diacetate dibehenate, glycerin tribehenate, tristearyl trimellitate, distearyl maleate, and methyl triacontanate. These fatty acid ester waxes may be used alone or in combination of two or more of them.

As these fatty acid esters, either commercially available products or synthetic products may be used.

The mold releasing agent may be a wax other than the fatty acid ester wax.

Examples of the wax other than the fatty acid ester wax include a polyolefin wax such as a low molecular weight polyethylene and a low molecular weight polypropylene, a branched hydrocarbon wax such as a microcrystalline wax, a long chain hydrocarbon-based wax such as a paraffin wax and Sasol wax, a dialkyl ketone-based wax such as distearyl ketone, and a fatty acid amide wax such as ethylenediamine behenylamide and trimellitic acid tristearylamide.

From the viewpoint of balance of the fixing property and the offset resistance, the content ratio of the mold releasing agent is preferably within a range of 1 to 25% by mass, and more preferably within a range of 5 to 20% by mass, when the total mass of the “polymer according to the present invention” is 100% by mass.

### <Charge Control Agent>

The toner base particles according to the present invention may contain a charge control agent.

The charge control agent used is not particularly limited as long as it is a substance capable of giving positive or negative charge by triboelectric charging and is colorless. Various known positive charge control agents and negative charge control agents may be used.

Specific examples of the positively chargeable charge control agent include a nigrosine-based dye such as “Nigrosine Base EX” (manufactured by Orient Chemical Industries Co. Ltd.), a quaternary ammonium salt such as “Quaternary ammonium salt P-51” (manufactured by Orient Chemical Industries Co. Ltd.), “Copy Charge PX VP435” (manufactured by Hoechst Japan Ltd.), an alkoxylated amine, an alkylamide, a molybdate chelating pigment, and an imidazole compound such as “PLZ1001” (manufactured by Shikoku Chemicals Corporation).

Examples of the negatively charged charge control agent include metal complexes such as “Bontron™ S-22”, “Bontron™ S-34”, “Bontron™ -81”, “Bontron™ E-84” (manufactured by Orient Chemical Industries Co.Ltd.), “Spiron Black TRH” (manufactured by Hodogaya Chemical Co., Ltd.), thioindigo pigments, quaternary ammonium salts such as “Copy Charge NX VP434” (manufactured by Hoechst Japan Ltd.), calixarene compounds such as “Bontron™ E-89” (manufactured by Orient Chemical Industries Co. Ltd.), boron compounds such as “LR147” (manufactured by Japan Carlit Co., Ltd.), and fluorine compounds such as magnesium fluoride and carbon fluoride.

As metal complexes used as negatively charging charge control agents, compounds having various structures such as metal oxycarboxylate complexes, metal dicarboxylate complexes, metal amino acid complexes, diketone metal complexes, diamine metal complexes, azo group-containing benzene-benzene derivative skeleton metal complexes, and azo group-containing benzene-naphthalene derivative skeleton metal complexes may be used.

The charging property of the toner is improved by configuring the toner base particles to contain the charge control agent in this manner.

The content ratio of the charge control agent is preferably within a range of 0.01 to 30% by mass, and more preferably within a range of 0.1 to 10% by mass, when the total mass of the base particles is 100% by mass.

### (Form of Toner Base Particle)

The form of the toner base particles according to the present invention is not particularly limited, and may be, for example, a so-called single-layer structure (a homogeneous structure that is not a core-shell type), a core-shell structure, a multilayer structure having three or more layers, or a domain-matrix structure.

### <External Additive>

In order to improve the fluidity, charging property, and cleaning property of the toner, an external additive such as fluidity increasing agent and cleaning assisting agent as an after treatment agent may be added to the toner base particles to constitute the toner according to the present invention.

Examples of the external additive are inorganic particles including inorganic oxide particles such as silica particles, alumina particles, and titanium oxide particles; inorganic stearic acid compound particles such as aluminum stearate particles and zinc stearate particles; and inorganic titanium acid compound particles such as strontium titanate particles and zinc titanate particles. These may be used alone or in combination of two or more of them.

In order to improve the heat-resistant storage property and environmental stability, these inorganic particles may be subjected to a surface treatment using a silane coupling agent, a titanium coupling agent, a higher aliphatic acid, or a silicone oil.

The addition amount of the external additive is preferably in the range of 0.05 to 5 parts by mass, more preferably in the range of 0.1 to 3 parts by mass, when the total mass of the toner base particles is 100 parts by mass.

### <Average Particle Diameter of Toner>

It is preferable that the toner of the present invention have an average particle diameter of 4 to 10 μm, more preferably 5 to 9 μm in volume-based median diameter (D₅₀). When the volume based median diameter (D₅₀) is within the above-described range, the transfer efficiency is improved, the halftone image quality is improved, and the image quality of fine lines and dots is improved.

In the present invention, the volume-based median diameter (D₅₀) of the toner is measured and calculated by using a measurement device including a “COULTER COUNTER 3” (manufactured by Beckman Coulter, Inc.) and a computer system installed with data processing software “Software V3.51” (manufactured by Beckman Coulter, Inc.) connected thereto.

Specifically, 0.02 g of the measurement sample (toner) is added to and blended in 20 mL of a surfactant solution in which a neutral detergent including a surfactant component is diluted by 10 times with pure water for the purpose of dispersing toner particles, for example. Then, ultrasonic dispersion is performed for 1 minute to prepare a toner particle dispersion liquid prepared. This toner particle dispersion liquid is poured into a beaker including ISOTON II (manufactured by Beckman Coulter, Inc.) in a sample stand with a pipette until the indicated concentration on the measurement device becomes 8%.

Here, by setting this concentration range, it is possible to obtain a reproducible measurement value. Then, measurement is made using the measurement device by setting the counter of the particles to be measured to 25,000 and the aperture diameter to be 50 μm. The frequency count is calculated by dividing the measurement range (1 to 30 μm) by 256. The particle diameter at 50% of the cumulative volume distribution is determined as the volume-based median diameter (D₅₀).

### [Production Method of Toner]

The production method of a toner of the present invention is not particularly limited, and for example, an emulsion aggregation method can be used. In the emulsion aggregation method, monomers as polymerization materials are emulsified and polymerized in an aqueous medium to prepare a binding resin particle dispersion liquid by miniemulsion polymerization, and, binding resin particles are aggregated and fused with a colorant particle dispersion liquid and, if necessary, a mold releasing agent particle dispersion liquid. Alternatively, the toner can be obtained by melting and kneading the binding resin, colorant, and, if necessary, mold releasing agent, etc., followed by pulverization, classification, etc. The toner can also be obtained by the suspension polymerization method described in JP 2010-191043A.

Among these, from the viewpoint that the particle diameter and the shape are easily controlled and the energy cost at the time of production can be reduced, it is preferable to use a production method using an emulsion aggregation method. As the emulsion aggregation method, a method described in JP h5-265252A, JP h6-329947A, and JP h9-15904A can be employed.

Hereinafter, a production method using such an emulsion aggregation method is described in detail.

The production method using an emulsion aggregation method can be performed by the following steps (1A) to (1C).

(1A) A step of preparing the binding resin particle dispersion liquid to prepare a dispersion liquid of the binding resin particles;

(1B) A step of preparing the colorant particle dispersion liquid to prepare a dispersion liquid of the colorant particles;

(1C) A step of preparing the mold releasing agent particle dispersion liquid to prepare a dispersion liquid of the mold releasing agent particles,

(2) A step of associating in which an aggregation agent is added to an aqueous medium in which the binding resin particles, the colorant particles, and the mold releasing agent particles are present to proceed salting out and simultaneously aggregation and fusion to form associated particles;

(3) A step of ripening in which toner particles are formed by controlling the shape of the associated particles;

(4) A step of filtration and washing in which the toner particles as a residue are separated from the aqueous medium by filtration to remove a surfactant and the like from the toner particles;

(5) A step of drying the washed toner particles; and

(6) A step of adding an external additive to the dried toner particles.

The steps (1A) to (1C) are described below.

### (1A) Step of Preparing Binding Resin Particle Dispersion Liquid

In this step, resin particles are formed by conventionally known emulsion polymerization, and the resin particles are aggregated and fused to form the binding resin particles. As an example, the monomers (in the case of “polymer according to the present invention,” the first monomer, the second monomer, and if necessary, the third monomer) to be used as polymerization materials for the binding resin are fed into an aqueous medium, dispersed, and polymerized with a water-soluble radical polymerization initiator to prepare a binding resin particle dispersion liquid.

Each of the monomers may be a commercially available one or a synthetic one.

examples of the water-soluble radical polymerization initiator include persulphates such as potassium persulfate and ammonium persulfate, azobis aminodipropane acetate, azobis cyanovaleric acid and salts thereof, and hydrogen peroxide.

Alternative to the emulsion polymerization described above, the binding resin particle dispersion liquid can also be prepared by dispersing the binding resin obtained by radical polymerization, etc. in an aqueous medium without using an organic solvent. Alternatively, the binding resin particle dispersion liquid can be obtained by dissolving the binding resin obtained by radical polymerization in an organic solvent such as ethyl acetate to make a solution, emulsifying and dispersing the solution in an aqueous medium using a dispersing machine, and then performing a process of removing the solvent.

Even when the binding resin particle dispersion liquid is prepared by a method other than emulsion polymerization, the preferred method of polymerizing the binding resin is radical polymerization from the viewpoint of easy synthesis.

Radical polymerization initiators used for radical polymerization include oil-soluble radical polymerization initiators as well as the water-soluble radical polymerization initiators mentioned above. Specific examples of the oil-soluble radical polymerization initiators include azo-based or diazo-based polymerization initiator, peroxide-based polymerization initiators, and the like.

Examples of the azo-based or diazo-based polymerization initiator include 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile.

Examples of the peroxide-based polymerization initiator include benzoyl peroxide, methyl ethyl ketone peroxide, diisopropyl peroxycarbonate, Cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexyl)propane, and tris-(t-butylperoxy)triazine.

Known chain transfer agents such as n-octyl mercaptan and n-octyl-3-mercaptopropionate may be used for radical polymerization, for example, if necessary.

For the purpose of dispersion, it is also preferable to polymerize in the presence of a known surfactant (for example, anionic surfactants such as sodium polyoxyethylene (2) dodecyl ether sulfate, Sodium dodecyl sulfate, and sodium dodecylbenzenesulfonate) as appropriate.

The polymerization temperature is preferably in the range of 50 to 100° C., and more preferably in the range of 55 to 90° C. depending on the types of monomer and polymerization initiator used. The time of polymerization is preferably 1 to 12 hours, for example, depending on the types of monomer and polymerization initiator used.

In the step of preparing the binding resin particle dispersion liquid, the mold releasing agent may be included in the binding resin particle dispersion liquid in advance, if necessary.

The volume-based median diameter of the binding resin particles in the dispersion liquid is preferably in the range of 50 to 300 nm. The volume-based median diameter of the binding resin particles in the dispersion liquid can be measured by dynamic light scattering method using “MICROTRAC UPA-150” (manufactured by Nikkiso Co. Ltd.).

### (1B) Step of Preparing Colorant Particle Dispersion Liquid

The preparing step of the colorant particle dispersion liquid is a step of preparing a dispersion liquid of colorant particles by dispersing the colorant in the form of fine particles in an aqueous medium.

The colorant may be dispersed using mechanical energy. The volume-based median diameter of the colorant particles in the dispersion liquid is preferably in the range of 10 to 300 nm, and more preferably in the range of 50 to 200 nm.

The volume-based median diameter of the colorant particles in the dispersion liquid can also be measured by a dynamic light scattering method using “MICROTRAC UPA-150” (manufactured by Nikkiso Co., Ltd.) as described above.

### (1C) Mold Releasing Agent Particle Dispersion Liquid Preparation Step

The preparation step of the mold releasing agent particle dispersion liquid is a step of preparing a dispersion liquid of the mold releasing agent particles by dispersing the mold releasing agent in the form of fine particles in an aqueous medium.

the mold releasing agent may be dispersed using mechanical energy. The volume-based median diameter of the mold releasing agent particles in the dispersion liquid is preferably in a range of 100 to 1000 nm, and more preferably in a range of 200 to 700 nm.

The volume-based median diameter of the mold releasing agent particles in the dispersion liquid can be measured by, for example, a laser diffraction particle size distribution analyzer LA-750 (manufactured by Horiba Ltd.).

### (Aqueous Medium)

Examples of the aqueous medium used in the steps of (1A) to (1C) include water, an aqueous medium composed of water as a main component (50% by mass or more) and a water-soluble solvent such as alcohol and glycol and an optional component such as a surfactant and a dispersant. As the aqueous medium, preferably, a mixture of water and a surfactant is used.

Examples of the water-soluble solvent described above include methanol, ethanol, isopropanol, butanol, acetone, methyl ethyl ketone, and tetrahydrofuran. Of these, alcohols such as methanol, ethanol, isopropanol, and butanol, which are organic solvents that do not dissolve the polymer, are preferable.

The surfactant may be a cationic surfactant, an anionic surfactant, or a nonionic surfactant. Examples of the cationic surfactant include dodecyl ammonium chloride, dodecyl ammonium bromide, dodecyl trimethyl ammonium bromide, dodecyl pyridinium chloride, dodecyl pyridinium bromide, and hexadecyl trimethyl ammonium bromide. Examples of the anionic surfactant include fatty acid soaps such as sodium stearate and sodium dodecanoate, sodium dodecylbenzenesulfonate, and sodium dodecylsulfate. Examples of the nonionic surfactant include polyoxyethylene dodecyl ether, polyoxyethylene hexadecyl ether, polyoxyethylene nonyl phenyl ether, polyoxyethylene lauryl ether, polyoxyethylene sorbitan monooleate ether, and monodecanoyl sucrose.

These surfactants may be used alone or in combination of two or more. Among them, preferably an anionic surfactant, more preferably sodium dodecylbenzenesulfonate and sodium dodecylsulfate may be used.

The addition amount of the surfactant is preferably in the range of 0.01 to 10 parts by mass, more preferably in the range of 0.04 to 2 parts by mass with respect to 100 parts by mass of the aqueous medium.

The steps from (2) Association step to (6) External additive addition step can be performed according to various conventionally known methods.

The aggregation agent used in (2) Association step is not particularly limited, and preferably selected among metal salts for use.

Examples of the metal salt include: monovalent metal salts of alkali metal salts such as sodium, potassium, and lithium; divalent metal salts such as calcium, magnesium, manganese, and copper; and trivalent metal salts such as iron and aluminum.

Specifically, examples of the metal salt include sodium chloride, potassium chloride, lithium chloride, calcium chloride, magnesium chloride, zinc chloride, copper sulfate, magnesium sulfate, manganese sulfate, and polyaluminum chloride. Among these, a divalent or trivalent metal salt is particularly preferable because aggregation can be performed with a smaller amount. These may be used alone or in combination of two or more.

### [Developer]

The toner of the present invention may be used, for example, as a one-component magnetic toner containing a magnetic material, as a two-component developer mixed with so-called carrier particles, or as a non-magnetic toner used alone. Any of these application is suitable.

Examples of the magnetic material include magnetite, y-hematite, and various ferrites.

As the carrier particles constituting the two-component developer, magnetic particles made of conventionally known materials such as metals such as iron, steel, nickel, cobalt, ferrite, and magnetite, and alloys of these metals with metals such as aluminum and lead can be used.

The carrier particles are preferably coated carrier particles obtained by coating the surfaces of magnetic particles with a coating agent such as a resin, or resin-dispersed carrier particles in which magnetic powder is dispersed in a binding resin.

The coating resin is not particularly limited, and examples of thereof include an olefin resin, a styrene resin, a styrene-acrylic resin, a silicone resin, a polyester resin, or a fluorine resin.

The resin constituting the resin-dispersed carrier particles is not particularly limited, and any known resin can be used. Examples of the resin constituting the resin-dispersed carrier particles include an acrylic resin, a styrene-acrylic resin, a polyester resin, a fluorine resin, and a phenol resin.

The volume-based median diameter of the carrier particles is preferably in the range of 20 to 100 ∥m, and more preferably in the range of 25 to 60 μm.

The volume-based median diameter of the carrier particles can be typically measured by a laser diffraction particle size analyzer measuring apparatus “HELOS” (manufactured by SYMPATEC Co., Ltd.) including a wet disperser.

The mixing amount of the toner particles with respect to the carrier particles is preferably in the range of 2 to 10% by mass, when the total mass of the toner particles and the carrier particles is 100% by mass.

### [Image Forming Method]

The toner of the present invention can be suitably used in an image forming method including a fixing step by a thermal pressure fixing method capable of applying pressure and heating. In particular, the present invention may be suitably used in an image forming method in which the fixing temperature in the fixing step is relatively low, i.e., in which the surface temperature of a heating member in a fixing nip portion is in the range of 80 to 110° C., preferably 80 to 95° C.

Further, it can also be suitably used for a high-speed fixing image forming method in which the fixing linear velocity is in the range of 200 to 600 mm/sec.

In this image forming method, specifically, the toner of the present invention as described above is used, for example, to develop an electrostatic latent image formed on a photoreceptor to obtain a toner image, and this toner image is transferred to an image support. Thereafter, the toner image transferred onto the image support is fixed to the image support by a fixing process of a thermal pressure fixing method, whereby a printed material on which a visible image is formed is obtained.

The toner of the present invention can be used in a monochrome image forming method or a full-color image forming method.

The full-color image forming method may be applied to any image forming method, such as a four-cycle image forming method using four types of color developing device relating to yellow, magenta, cyan, and black, and one photoreceptor, or a tandem image forming method using image forming units each having a color developing device relating to each color and a photoreceptor for respective colors.

### EXAMPLES

Hereinafter, the present invention will be specifically described with reference to Examples, but the present invention is not limited thereto. In the following examples, unless otherwise specified, the operation was carried out at room temperature (25° C.). Also, unless otherwise noted, “%” and “parts” mean “% by mass” and “parts by mass”, respectively.

In the Examples, the following first monomers M1 to M5 and the second monomers M6 to M10 were used.

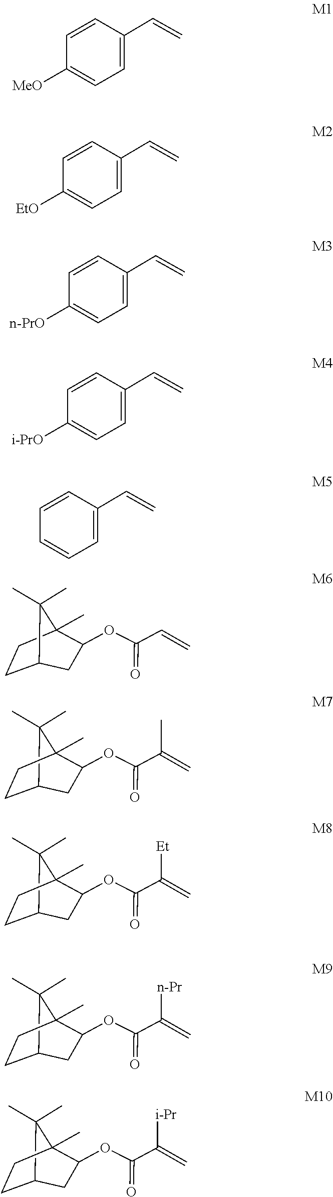

### [Production of Toner 1]

### <Preparation of Binding Resin Particle Dispersion Liquid 1>

A surfactant solution in which 8 g of sodium dodecyl sulfate was dissolved in 3 liters of ion-exchanged water was charged into a stainless steel kettle (SUS kettle) with 5 liter capacity fitted with a stirring device, a temperature sensor, a cooling pipe, and a nitrogen introducing device, and the temperature was raised to a liquid temperature of 80° C. while stirring at a stirring speed of 230 rpm under a nitrogen stream.

To this surfactant solution, an initiator solution in which 10 g of potassium persulfate was dissolved in 200 g of ion-exchanged water was added, and the temperature was set to 80° C., and then the following monomer mixture liquid was added dropwise over a period of 100 minutes.

—Monomer Mixture Liquid—

| | |
|---|---|
| First monomer M1 | 282 g |
| Second monomer M6 | 290 g |
| n-Butyl acrylate (nBA) | 193 g |
| Methacrylic acid (MAA) | 40 g |
| n-Octyl-3-mercaptopropionate | 5.5 g |

The system was heated at 80° C. for 2 hours and stirred to perform polymerization, and a binding resin particle dispersion liquid 1 was prepared.

The volume-based median diameter of the binding resin particles in the obtained binding resin particle dispersion liquid 1 was measured by a dynamic light scattering method using a “MICROTRAC UPA-150” (manufactured by Nikkiso Co., Ltd.) and was found to be 115 nm.

The peak molecular weight of the polymer included in the binding resin was found to be 21100 as a result of the following measurement.

Using a device “HLC-8220” (manufactured by TOSOH Corporation) and a column set “TSK guard column+3×TSK gel Super HZM-M” (manufactured by TOSOH Corporation), tetrahydrofuran (THF) was flowed as a carrier solvent at a flow rate of 0.2 mL/min while maintaining the column temperature at 40° C., and the measurement sample was dissolved in the tetrahydrofuran at a concentration of 1 mg/mL under a dissolution condition in which the measurement sample was treated for 5 minutes using an ultrasonic disperser at room temperature (25° C.).

Then, it was treated with a membrane filter having a pore size of 0.2 μm to obtain a sample solution, 10 μL of this sample solution was injected into the device together with the above carrier solvent, the molecular weight distribution of the measurement sample was detected using a refractive index detector (RI detector), and the peak molecular weight was determined.

### <Preparation of Colorant Particle Dispersion Liquid 1>

| | |
|---|---|
| Colorant: Carbon black | 10 parts by mass |
| 20% Anionic surfactant | 1.5 parts by mass |
| Ion-exchanged water | 90 parts by mass |

The above colorant was carbon black (Mogul™ L manufactured by Cabot Co., Ltd.). The above 20% anionic surfactant was 20% aqueous solution of sodium dodecylbenzene sulfonate.

The above components were mixed and dispersed in an SC mill to obtain a colorant particle dispersion liquid 1. The volume-based median diameter of the colorant particles in the dispersion liquid was measured by a dynamic-light scattering method using a “MICROTRAC UPA-150” (manufactured by Nikkiso Co., Ltd.) and was found to be 155 nm.

### <Preparation of Mold Releasing Agent Particle Dispersion Liquid 1>

| | |
|---|---|
| Behenyl behenate | 100 parts by mass |
| Sodium dodecyl sulfate | 5 parts by mass |
| Ion-exchanged water | 240 parts by mass |

The above components were dispersed in a round stainless steel flask using a homogenizer “Ultratalax™ T50” (manufactured by IKA Co., Ltd.) for 10 minutes, and then subjected to dispersion treatment with a pressure ejection type homogenizer to obtain a mold releasing agent particle dispersion liquid 1. The volume-based median diameter of the mold releasing agent particles in the dispersion liquid was measured using the laser diffraction particle size distribution analyzer LA-750 (manufactured by Horiba Ltd.) and was found to be 530 nm.

### <Preparation of Toner Base Particle Dispersion Liquid 1>

| | |
|---|---|
| Binding resin particle dispersion liquid 1 | 237 parts by mass |
| Colorant particle dispersion liquid 1 | 42 parts by mass |
| Mold releasing agent particle dispersion liquid 1 | 18 parts by mass |
| Polyaluminum chloride | 1.8 parts by mass |
| Ion-exchanged water | 600 parts by mass |

The above components were mixed using a homogenizer “Ultratalax™ T50” (manufactured by IKA Co., Ltd.) in a round stainless steel flask, dispersed, and then heated to 55° C. while stirring the inside of the flask in an oil bath for heating. After holding for 30 minutes at 55° C., it was confirmed that aggregated particles having a volume-based median diameter (D₅₀) of 4.8 um were generated in the solution.

When the temperature of the heating oil bath was further increased and held at 56° C. for 2 hours, the volume-based median diameter (D₅₀) was 5.9 μam.

Thereafter, 1 mol/L of sodium hydroxide was added into the system to adjust the pH of the system to 5.0 at 56° C., and then the round stainless steel flask was sealed using a magnetic seal and heated to 98° C. while continuing stirring. Fusion of the binder resin particles was completed by continuing stirring for 6 hours to prepare a toner base particle dispersion liquid 1. The volume-based median diameter (D₅₀) of the toner base particles in the dispersion liquid was 6.1 μm.

### <Washing and Drying Step>

The toner base particle dispersion liquid 1 was subjected to solid-liquid separation using a basket-type centrifugal separator “MARK III Model No. 60×40” (manufactured by Matsumoto Machine Sales Co., Ltd.) to form a wet cake of toner base particles.

The wet cake was washed with ion-exchanged water at 45° C. until the electrical conductivity of the filtrate became 5 μS/cm in the basket-type centrifugal separator described above, then transferred to a “Flash Jet Dryer” (manufactured by Seishin Enterprise Co., Ltd.), and dried until the moisture content became 0.5% by mass to obtain toner base particles.

### <External Additive Treatment of Toner Base Particle>

To 100 parts by mass of the toner base particles obtained as above, 1 part by mass of hydrophobic silica (number average primary particle diameter=12 nm) and 0.3 parts by mass of hydrophobic titania (number average primary particle diameter=20 nm) were added, and the mixture was mixed with a Henschel™ mixer to perform an external additive treatment to produce a toner 1.

### [Production of Toners 2 to 16]

Toners 2 to 16 were produced in the same manner as in the production of the Toner 1, except that the combination and added amount [% by mass] of the monomers in the monomer mixture were changed as shown in Table I below, though 5.5 g of n-octyl-3-mercaptopropionate was not changed. In the following Table I, nBA is n-butyl acrylate, 2 EHA is 2-ethylhexyl acrylate, MAA is methacrylic acid, and AA is acrylic acid.

The volume-based median diameter of the binding resin particles in the binding resin particle dispersion liquid for each toner was 120 nm.

The peak molecular weight of the polymer in the binding resin for each toner was as shown in Table I below.

### [Preparation of Two-Component Developer]

100 parts by mass of ferrite particles (volume-based median diameter: 50 μm (manufactured by Powdertech Co., Ltd.) and 4 parts by mass of methyl methacrylate-cyclohexyl methacrylate copolymer resin (volume-based median diameter of primary particles: 85 nm) were put into a horizontal stirring blade type high-speed stirrer, mixed for 15 minutes under the conditions at the peripheral speed of the stirring blade of 8 m/second and at a temperature of 30° C., and after being heated to 120° C., stirring was continued for 4 hours. Thereafter, a resin-coated carrier was produced by cooling and removing debris of methyl methacrylate-cyclohexyl methacrylate copolymer resin using a 200 mesh sieve.

The resin-coated carrier was mixed with each of the above toners 1 to 16 so that the concentration of the toner with respect to the total mass of the toner and the carrier was 7% by mass, and two-component developers 1 to 22 were produced.

### [Evaluation]

The two-component developers 1 to 16 were used to evaluate the following evaluation items, and the evaluation results are shown in Table II below.

### (1) Fixation at Fold

As an image forming apparatus, a commercially available multifunction peripheral “bizhub™ PRO C6500” (manufactured by Konica Minolta, Inc.) was used, and each of the above-mentioned two-component developers 1 to 16 was mounted as a developer in the apparatus. Images were formed using a thick paper weighing 350 g/m² as an image support under normal temperature and normal humidity (temperature of 20° C., relative humidity of 50% RH) while the surface temperature of a fixing heat member in the fixing unit for the hot-roll fixing method was 150° C., and a solid image on which 5 g/m³ toners were fixed was obtained as a visual image.

After that, the fixed solid image was folded using a folding device, and air at 0.35 MPa was blown onto it. The state of the fold was evaluated in five levels as follows, referring to a limit sample. Rank 3 or higher is acceptable.

Rank 5: No peeling at the fold

Rank 4: Slight peeling along the fold

Rank 3: Partially peeling along the fold

Rank 2: Peeling in thin lines along the fold

Rank 1: Peeling in thick lines along the fold

### (2) Measurement of Adhesion Strength

Each of the above-mentioned two-component developers 1 to 16 was mounted as a developer in a copying machine “bizhub PRESS™ C 1070” (manufactured by Konica Minolta, Inc.), and adhesion strength was measured.

Specifically, under normal temperature and normal humidity (temperature of 20° C. and humidity of 50% RH), after setting an adhesion amount of toner on “OK topcoated paper” (manufactured by Oji Paper Co., Ltd., basis weight: 157 g/m²) to be 8.0 g/m², the temperature of a lower roller was set to 70° C., solid images were printed on five A3-size sheets of paper in duplex output mode and the sheets were output. On top of the output sheet bundle, 500 sheets of A3 size paper were mounted and left for 2 hours. The sheets were placed on a flat table, and a tape was attached to the tip of the topmost sheet to slide the sheet slowly in a horizontal direction.

At this time, the sheets other than the topmost one are fixed to the table so as not to move. The force required to slide the sheet of paper was measured using a spring scale. This measurement was repeated four times from the top, and the average value of the force [N] indicated by the spring scale was determined as the adhesion strength. When the adhesion strength was 2.0 N or less, the sheet was judged to be at a practicable level.

### (3) Heat-Resistant Storage Property

0.5 g of each of the above two-component developers 1 to 16 was taken in a 10 mL glass bottle having an inner diameter of 21 mm, and the lid was closed. After shaking 600 times at room temperature using a shaker “Tap Denser KYT-2000” (manufactured by Seishin Enterprise Co., Ltd.), the lid was opened, and it was left for 2 hours under a temperature of 55° C. and a humidity of 35% RH.

After being left for two hours, agglomerates of the above two-component developer were placed on a sieve of 48 mesh (mesh opening: 350 μm) with care so as not to disaggregate, and was set in a “powder tester” (manufactured by Hosokawa Micron Corp.) being fixed with a holding bar and a knob nut. A vibration intensity was adjusted to mm in feed width, and vibration was applied for 10 seconds.

After that, the mass amount of the two-component developer remaining on the sieve was measured, and the toner agglomeration ratio At [% by mass] was calculated using the formula below.

At [% by mass]=(mass of two-component developer remaining on sieve [g])/0.5 [g]1 00

Based on the calculated toner agglomeration ratio At, the heat resistant storage property of the two-component developer was evaluated according to the following criteria. A, B, and C were considered acceptable for practical use.

A: Toner agglomeration ratio At was less than 15% by mass. (The developer had an extremely good heat-resistant storage property.)
B: Toner agglomeration ratio At was 15% by mass or more and less than 20% by mass. (The developer had a good heat-resistant storage property.)
C: Toner agglomeration ratio At was 20% by mass or more and less than 25% by mass. (The developer had a slightly poor heat-resistant storage property.)
D: Toner agglomeration ratio At was 25% by mass or more. (The developer had a poor heat-resistant storage property and was unacceptable for use.)

TABLE 1

| | First monomer | | | | | Second monomer | | | | | Third monomer |
|---|---|---|---|---|---|---|---|---|---|---|---|
| | [% by mass] | | | | | [% by mass] | | | | | [% by mass] |
| No. | M1 | M2 | M3 | M4 | M5 | M6 | M7 | M8 | M9 | M10 | nBA |
| 1 | 35.0 | — | — | — | — | 36.0 | — | — | — | — | 24.0 |
| 2 | 12.0 | — | — | — | — | 60.0 | — | — | — | — | 23.0 |
| 3 | 19.0 | — | — | — | — | 53.0 | — | — | — | — | 23.0 |
| 4 | 54.0 | — | — | — | — | 20.0 | — | — | — | — | 10.0 |
| 5 | 60.5 | — | — | — | — | 11.0 | — | — | — | — | 23.5 |
| 6 | — | 39.5 | — | — | — | 39.5 | — | — | — | — | 16.0 |
| 7 | — | — | 38.5 | — | — | 385 | — | — | — | — | 18.0 |
| 8 | — | — | — | 37.0 | — | 30.0 | — | — | — | — | 10.0 |
| 9 | — | — | — | — | 36.5 | 36.5 | — | — | — | — | 12.0 |
| 10 | 31.5 | — | — | — | — | — | 31.5 | — | — | — | 32.0 |
| 11 | 35.0 | — | — | — | — | — | — | 35.0 | — | — | 15.0 |
| 12 | 36.0 | — | — | — | — | — | — | — | 36.0 | | 23.0 |
| 13 | 37.0 | — | — | — | — | — | — | — | — | 37.0 | 11.0 |
| 14 | — | — | — | — | 68.5 | — | — | — | — | — | 26.5 |
| 15 | — | — | — | — | 50.5 | — | — | — | — | — | 43.5 |
| 16 | — | — | — | — | — | 72.0 | — | — | — | — | 23.0 |

| | | | | | | | | Heat- | |
|---|---|---|---|---|---|---|---|---|---|
| | Third monomer | | | Composition | Peak | | Adhesion | resistant | |
| | [% by mass] | | | ratio X | molecular | Fixation | strength | property | |
| No. | 2EHA | MAA | AA | [% by mass] | weight | at fold | [N] | storage | Remarks |
| 1 | — | 5.0 | — | 49 | 21550 | 5 | 1.2 | A | Present |
| | | | | | | | | | invention |
| 2 | — | 4.0 | 1.0 | 17 | 21300 | 3 | 1.3 | A | Present |
| | | | | | | | | | invention |
| 3 | — | 5.0 | — | 26 | 21900 | 4 | 1.4 | A | Present |
| | | | | | | | | | invention |
| 4 | 11.0 | 5.0 | — | 73 | 21050 | 5 | 1.6 | A | Present |
| | | | | | | | | | invention |
| 5 | — | 3.0 | 2.0 | 85 | 21600 | 5 | 1.9 | A | Present |
| | | | | | | | | | invention |
| 6 | — | 5.0 | — | 50 | 21950 | 4 | 1.3 | B | Present |
| | | | | | | | | | invention |
| 7 | — | 5.0 | — | 50 | 19500 | 3 | 1.3 | B | Present |
| | | | | | | | | | invention |
| 8 | — | 5.0 | — | 49 | 21500 | 3 | 1.4 | B | Present |
| | | | | | | | | | invention |
| 9 | 10.0 | 5.0 | — | 50 | 22100 | 5 | 1.2 | A | Present |
| | | | | | | | | | invention |
| 10 | — | 5.0 | — | 50 | 21050 | 4 | 1.4 | A | Present |
| | | | | | | | | | invention |
| 11 | 10.0 | 5.0 | — | 50 | 19600 | 4 | 1.6 | B | Present |
| | | | | | | | | | invention |
| 12 | — | 5.0 | — | 50 | 21050 | 4 | 1.8 | B | Present |
| | | | | | | | | | invention |
| 13 | 10.0 | 5.0 | — | 50 | 19800 | 3 | 1.8 | B | Present |
| | | | | | | | | | invention |
| 14 | — | 5.0 | — | 100 | 21500 | 4 | 2.3 | B | Comparative |
| | | | | | | | | | example |
| 15 | — | 6.0 | — | 100 | 23100 | 5 | 1.3 | D | Comparative |
| | | | | | | | | | example |
| 16 | — | 5.0 | — | 0 | 21100 | 2 | 1.2 | B | Comparative |
| | | | | | | | | | example |

The above results show that the electrostatic latent image developing toner of the present invention, which contains a polymer having structural units represented by the above general formula (1) the above general formula (2), makes it possible to suppress electrostatic adhesion of printed materials while satisfying the heat-resistant storage property and the low-temperature fixing property.

Although embodiments of the present invention have been described and illustrated in detail, the disclosed embodiments are made for purposes of illustration and example only and not limitation. The scope of the present invention should be interpreted by terms of the appended claims.

What is claimed is:

1. An electrostatic latent image developing toner comprising:
toner base particles including a binding resin and a colorant, the binding resin being at least one of:
a first polymer having a first structural unit represented by a general formula (1) below and a second polymer having a second structural unit represented by a general formula (2) below; and
a copolymer having at least one of the first structural unit and the second structural unit, 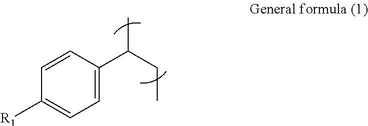
wherein, in the general formula (1), R₁ represents a hydrogen atom or an alkoxy group having one to three carbon atoms, and 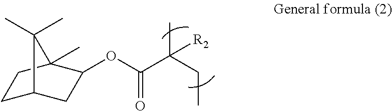
wherein, in the general formula (2), R₂ represents a hydrogen atom or an alkyl group having one to three carbon atoms.

2. The electrostatic latent image developing toner according to claim 1, wherein toner base particles include the copolymer having the first structural unit and the second structural unit as the binding resin.

3. The electrostatic latent image developing toner according to claim 1, wherein, in the general formula (1), R₁ represents a hydrogen atom or a methoxy group.

4. The electrostatic latent image developing toner according to claim 1, wherein, in the general formula (2), R₂ represents a hydrogen atom or a methyl group.

5. The electrostatic latent image developing toner according to claim 1, wherein, in the general formula (1), R₁ represents a methoxy group.

6. The electrostatic latent image developing toner according to claim 1, wherein, in the general formula (2), R₂ represents a hydrogen atom.

7. The electrostatic latent image developing toner according to claim 1, wherein the copolymer further has a third structural unit that is different from the first structural unit and the second structural unit.

8. The electrostatic latent image developing toner according to claim 1,
wherein a composition ratio X represented by a formula (I) below is in a range of 25 to 75% by mass:
X [mass %]=W₁/(W₁+W₂)×100 Formula (I):
wherein, in the formula (I), W₁ represents a mass of the first structural unit in a total of the binding resin, and W₂ represents a mass of the second structural unit in the total of the binding resin.

9. The electrostatic latent image developing toner according to claim 7, wherein the third structural unit is derived from at least one of an acrylic ester and a methacrylic ester.

10. The electrostatic latent image developing toner according to claim 7, wherein the third structural unit is derived from at least one of acrylic acid, n-butyl acrylate, 2-ethylhexyl acrylate, and methacrylic acid.

11. A method of producing an electrostatic latent image developing toner comprising toner base particles including a binding resin and a colorant, the method comprising:
preparing a particle dispersion liquid of the binding resin by copolymerizing a first monomer having a structure represented by a general formula (3) below and a second monomer having a structure represented by a general formula (4) below, 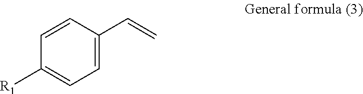
wherein, in the general formula (3), R₁ represents a hydrogen atom or an alkoxy group having one to three carbon atoms, and 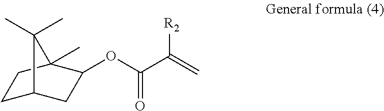
wherein, in the general formula (4), R₂ represents a hydrogen atom or an alkyl group having one to three carbon atoms.
